(19) United States
(12) Patent Application Publication
(10) Pub. No.: US 2021/0253454 A1
(43) Pub. Date: Aug. 19, 2021

(54) MICELLAR DELIVERY METHOD

(71) Applicant: EVONIK OPERATIONS GMBH, Essen (DE)

(72) Inventors: Ricky MITTIGA, Tonawanda, NY (US); Weidong AN, Williamsville, NY (US); John ROVISON, Sanborn, NY (US); Elena PISANOVA, Amherst, NY (US)

(73) Assignee: EVONIK OPERATIONS GMBH, Essen (DE)

(21) Appl. No.: 17/253,953

(22) PCT Filed: Jun. 19, 2019
(86) PCT No.: PCT/US2019/037957

§ 371 Date: Dec. 18, 2020

Related U.S. Application Data
(60) Provisional application No. 62/686,924, filed on Jun. 19, 2018.

(51) Int. Cl. C02F 1/50; A01N 25/04; A01N 37/02; A01N 37/16; A01N 25/22

(52) U.S. Cl. CPC C02F 1/50; A01N 25/04; A01N 37/02; C02F 2103/007; A01N 25/22; C02F 2303/04; A01N 37/16

(57) ABSTRACT

Provided herein are compositions and methods for treatment of microbially contaminated water and microbially contaminated surfaces. The compositions can include a micellar system comprising an equilibrium peroxycarboxylic acid and a surfactant.

### CROSS REFERENCE TO RELATED APPLICATIONS

This application claims priority under 35 U.S.C. § 119(e)(1) from U.S. Provisional Application Ser. No. 62/686,924, filed Jun. 19, 2018, the contents of which are incorporated herein by reference.

### FIELD OF THE INVENTION

The present invention relates to compositions and methods for treatment of microbially contaminated water and microbially contaminated surfaces.

### BACKGROUND OF THE INVENTION

Microbial contamination of water used in industrial applications can result in the production of biofilms on industrial equipment. A typical biofilm is made up of a biopolymer matrix embedded with bacteria. Biofilms can develop on equipment used in many different industries in which equipment surfaces are exposed to microbially contaminated water, for example, equipment used in oil- and gas-field operations or in circulating cooling water systems. Biofilms can clog and corrode equipment such as pipelines and drilling machinery. Such corrosion is often referred to as bio-corrosion or microbiologically influenced corrosion (“MIC”). Biofilms are challenging to eliminate with standard antimicrobial agents. Standard agents may not efficiently penetrate biofilms and are not always effective under field conditions that can include extreme temperatures and high salinity. Severe biofilm formation can require costly and time-consuming shutdown of operations for cleaning. Well drilling equipment may need to be dismantled and cleaned above ground. There is a continuing need for methods of treating water used in industrial applications that effectively targets biofilms and any microbes that can form biofilms.

### SUMMARY OF THE INVENTION

Provided herein are compositions and methods for treatment of microbially contaminated water and microbially contaminated surfaces. The compositions can include a source of active oxygen, an organic acid, and a surfactant, wherein the organic acid and the source of active oxygen react to form an equilibrium peroxycarboxylic acid solution in a micellar system. The source of active oxygen can be hydrogen peroxide, calcium peroxide, percarbonates, carbamide peroxide, and mixtures thereof. In some embodiments the source of active oxygen can be hydrogen peroxide. In some embodiments, the organic acid can be acetic acid, formic acid, propionic acid, octanoic acid, and citric acid. The surfactant can be a non-ionic surfactant, an anionic surfactant or a cationic surfactant. In some embodiments, the surfactant can be a linear alcohol or derivative of a linear alcohol. The linear alcohol can be a C6-C12 linear alcohol. In some embodiments, the surfactant can be an alcohol ethoxylate, an alkoxylated linear alcohol, ethoxylated castor oil, an alkoxylated fatty acid, an alkoxylated coconut oil, an alcohol sulfate, a phosphated mono glyceride, a phosphated diglyceride, or a combination thereof. The equilibrium peroxycarboxylic acid solution can include a percarboxylic acid, an organic acid, and hydrogen peroxide. In some embodiments, the percarboxylic acid can be a C2-C12 percarboxylic acid. In some embodiments the percarboxylic acid is peracetic acid.

Also provided are methods of preparing a micellar system comprising an equilibrium peroxycarboxylic acid solution. The method can include the steps of combining about 30-50 weight % of organic acid, about 10-20 weight % of a source of active oxygen, and about 1-15 weight % of a surfactant in an aqueous solution; and incubating the aqueous solution for a time sufficient to generate the equilibrium peroxycarboxylic acid solution.

Also provided are methods of reducing microbial contamination in an aqueous fluid. The method can include the steps of contacting the aqueous fluid with a composition comprising a micellar system comprising an equilibrium peroxycarboxylic acid solution and a surfactant for a time sufficient to reduce microbial levels in the aqueous fluid. The aqueous fluid can be fresh water, pond water, sea water, brackish water, a brine, an oilfield fluid, produced water, tower water or a combination thereof.

Also provided are methods of reducing microbial contamination in a subterranean environment comprising a wellbore. The method can include the steps of introducing an aqueous composition comprising a micellar system comprising an equilibrium peroxycarboxylic acid solution and a surfactant into the wellbore; and contacting the wellbore with the aqueous composition for a time sufficient to reduce microbial contamination. The microbial contamination can include free-floating microbes, sessile microbes, or a biofilm or combination thereof. Also provided are methods of reducing microbial contamination of a surface. The method can include contacting the surface with an aqueous composition comprising a micellar system comprising an equilibrium peroxycarboxylic acid solution and a surfactant for a time sufficient to reduce microbial contamination. The microbial contamination can include a biofilm.

Also provided are methods of reducing microbial contamination of a surface. The method can include contacting the surface with an aqueous composition comprising a micellar system comprising an equilibrium peroxycarboxylic acid solution and a surfactant for a time sufficient to reduce microbial contamination. The microbial contamination can include a biofilm. The surface can include industrial equipment, medical equipment, or equipment used in food preparation.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1a is a photograph of a biofilm on a control glass coupon after treatment with water for 72 hrs. FIG. 1b. is a photograph of a biofilm on a glass coupon after treatment with a PAA solution (PAA:hydrogen peroxide ratio of 15.7:10.4). FIG. 1c is a photograph of a biofilm on a glass coupon after treatment with Composition 1 as shown in Table 8. FIG. 1d is a photograph of a biofilm on a glass coupon after treatment with Composition 2 as shown in Table 8.

### DETAILED DESCRIPTION OF THE PREFERRED EMBODIMENT

This description of preferred embodiments is intended to be read in connection with the accompanying drawings, which are to be considered part of the entire written description of this invention. The drawing FIGURES are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing FIGURE under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. When only a single machine is illustrated, the term “machine” shall also be taken to include any collection of machines that individually or jointly execute a set (or multiple sets) of instructions to perform any one or more of the methodologies discussed herein. In the claims, means-plus-function clauses, if used, are intended to cover the structures described, suggested, or rendered obvious by the written description or drawings for performing the recited function, including not only structural equivalents but also equivalent structures.

The present invention is directed to compositions and methods for treatment of microbially contaminated water and microbially contaminated surfaces. The inventors have found that a composition comprising a source of active oxygen, an organic acid, and a surfactant generated an equilibrium percarboxylic acid solution in a micellar system. Surprisingly, the micellar system mitigated decomposition of the percarboxylic acid. The percarboxylic acid in the micellar system was stable for an extended period of time, even at elevated temperatures and in the presence of a high concentration of salts. The micellar system provided an effective delivery system for the equilibrium percarboxylic acid solution. Upon dilution, the active percarboxylic acid was released from the micellar system. The compositions showed biocidal activity against both free-floating bacteria and biofilms. The compositions also effectively solubilized tar, sludge, and gelled polymer that are typically deposited on the surfaces and equipment used in in oil and gas wells. These stable compositions can be provided as a single component premixed formulation that can be added directly to the aqueous solution without the need to combine multiple reagents on site. These stable formulations can be effectively stored and transported.

We may refer to these compositions as equilibrium percarboxylic acid solutions in a micellar system or as micellar equilibrium percarboxylic acid solutions or as micellar delivery systems. Percarboxylic acid solutions, for example, peracetic acid solutions, typically are dynamic equilibrium mixtures of water, acetic acid, hydrogen peroxide and peracetic acid as shown in equation 1 below:

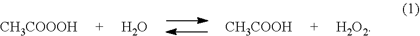

The dynamic equilibrium between the peracetic acid, acetic acid, hydrogen peroxide, and water helps maintain peracetic acid stability and peracetic acid concentration. One of ordinary skill in the art will recognize that in a dynamic equilibrium solution, the nominal measured concentration of a peracetic acid stock solution is an equilibrium concentration and the actual measured concentration at any point in time will vary slightly.

The compositions disclosed herein are generally useful for the treatment of water used in industrial applications, for example, for water that flows through pipes or other subterranean formations, such as in the energy industry, for example in oil- and gasfield operations as well as in paper or pulp industries. The compositions disclosed herein are also generally useful for cleaning and sanitizing surfaces or equipment, particularly equipment used in oil and gasfield operations.

Without being limited by any particular theory, it appears that the surfactant stabilizes the percarboxylic acid by forming micelles. Micelles are globular structures formed by self-assembly of amphiphilic molecules, such as surfactants. Amphiphilic molecules have a hydrophilic/polar region, also referred to as a “head,” and a hydrophobic/nonpolar region, also referred to as a “tail.” Micelles are typically formed in aqueous solutions such that the polar head region faces the outside surface of the micelle and the nonpolar tail region faces the inside surface to form the core. Micelles are generally formed by surfactants when the critical micelle concentration (CMC) is reached. The CMC is the concentration of the surfactant below which the surfactant is monomeric in solution and above which all additional surfactant forms micelles. Micelles are typically spherical, ranging in size from about 2 to 900 nm depending upon the composition. Regarding the compositions disclosed herein, the polar groups of the surfactant form strong bonds with the peroxycarboxylic acid as it is generated. The micelles appear to surround and stabilize the peroxycarboxylic acid, mitigating decomposition of the peroxycarboxylic acid that typically occurs in aqueous solutions. When the micellar solution is added to the aqueous solution to be treated, the micellar solution becomes diluted below the CMC concentration of the surfactant, the micelles are disrupted, and the peroxycarboxylic acid is released.

The compositions disclosed herein include a source of active oxygen. We may also refer to the source of active oxygen as a peroxygen source. The source of active oxygen can be hydrogen peroxide, calcium peroxide, carbamide peroxide or a percarbonate or combination of one or more of hydrogen peroxide, calcium peroxide, carbamide peroxide, perborate or a percarbonate. The percarbonate can be sodium percarbonate. sodium peroxocarbonate, sodium peroxodicarbonate, potassium percarbonate, potassium peroxocarbonate, or potassium peroxodicarbonate. In some embodiments, the compositions can include or exclude hydrogen peroxide, calcium peroxide, carbamide peroxide or a percarbonate or combination of one or more of hydrogen peroxide, calcium peroxide, carbamide peroxide, perborate or a percarbonate.

The concentration of the source of active oxygen can vary. The concentration of the source of active oxygen can range from about 8% by weight to about 25% by weight. Thus, the source of active oxygen concentration can be about 8% by weight, 8.5% by weight, 9% by weight, 9.5% by weight, 10% by weight, 10.5% by weight, 11% by weight, 11.5% by weight, 12% by weight, 12.5% by weight, 13% by weight, 13.5% by weight, 14% by weight, 14.5% by weight, 15% by weight, 15.5% by weight, 16% by weight, 16.5% by weight, 17% by weight, 17.5% by weight, 18% by weight, 18.5% by weight, 19% by weight, 19.5% by weight, 20% by weight, 20.5% by weight, 21% by weight, 21.5% by weight, 22% by weight, 22.5% by weight, 23% by weight, 23.5% by weight, 24% by weight, 24.5% by weight, or 25% by weight.

The compositions disclosed herein also include an organic acid. Exemplary organic acids can include, without limitation, acetic acid, citric acid, formic acid, propionic acid, isocitric acid, aconitic acid and propane-1,2,3-tricarboxylic acid, lactic acid, benzoic acid, salicylic acid, glycolic acid, oxalic acid, sorbic acid, malic acid, maleic acid, tartaric acid, octanoic acid, ascorbic acid, or fumaric acid. In some embodiments, the compositions can include or exclude acetic acid, citric acid, formic acid, propionic acid, isocitric acid, aconitic acid and propane-1,2,3-tricarboxylic acid, lactic acid, benzoic acid, salicylic acid, glycolic acid, oxalic acid, sorbic acid, malic acid, maleic acid, tartaric acid, octanoic acid, ascorbic acid, or fumaric acid.

The concentration of the organic acid can vary. The concentration of the organic acid can range from about 20% by weight to about 60% by weight. Thus, the organic acid concentration can be about 20% by weight, 22% by weight, 25% by weight, 30% by weight, 35% by weight, 36% by weight, 37% by weight, 38% by weight, 40% by weight, that 42% by weight, 45% by weight, 46% by weight, 47% by weight, 48% by weight, 49% by weight, 50% by weight, 55% by weight, or 60% by weight.

The compositions disclosed herein also include a surfactant. The surfactant can be a linear alcohol or a derivative of a linear alcohol. In some embodiments, the linear alcohol or derivative of the linear alcohol can be a C6-C15 linear alcohol. A derivative of a linear alcohol can be a linear alcohol in which the —OH groups on the linear alcohol are alkoxylated. In some embodiments, the —OH groups can be ethoxylated, e.g., ethers, such as ethoxylated or alkoxylated alcohols containing the ether group C—O—C. The degree of ethoxylation can vary. The ethoxylated linear alcohol can include, for example, 1, 2, 3, 4, 5, 6, 7, 8, 9, 10, 11, 12, or more ethylene oxide units. Such ethoxylated linear alcohols are generally nonionic surfactants. In some embodiments, the —OH groups can be propoxylated.

In some embodiments, the derivative of a linear alcohol can be an ester, for example, a sulfate, such as sodium dodecyl sulfate (SDS), or a phosphate, for example, phosphated mono and diglycerides (PDMG). These surfactants are generally esters of an alcohol and an inorganic acid. Such esters are generally anionic surfactants.

Useful surfactants are chemically stable surfactants that are compatible with the oxidizers disclosed herein and that do not promote phase separation, solidification, or gas evolution upon combination with the oxidizers. Useful surfactants are also compatible with components of the oilfield fluids such as clay stabilizers, corrosion inhibitors, and friction reducers. Such surfactants are effective emulsifiers, that is, the result in the production of stable micelles. Useful surfactants are tolerant of divalent cations typically present in aqueous solutions such as reservoir brines. Such useful surfactants are also stable at temperatures up to about 120° C., and will be effective in subterranean wells that can reach temperatures up to about 95° C. Useful features of surfactants also include efficient cleaning properties, rinsing characteristics, wetting ability, and biodegradability, such as can be found in plant-based biodegradable surfactants.

The surfactant can be a non-ionic surfactant, an anionic surfactant, or a cationic surfactant. The surfactant can include or exclude a non-ionic surfactant, an anionic surfactant or a cationic surfactant. Exemplary non-ionic surfactants include without limitation, alcohol ethoxylates, alkoxylated linear alcohols, ethoxylated castor oil, alkoxylated fatty acid, and alkoxylated coconut oil. A non-ionic surfactant can be a biodegradable synthetic or plant-based surfactant.

Anionic surfactants can include, for example, alcohol sulfates, such as sodium dodecyl sulfate (SDS). SDS is typically produced from inexpensive coconut and palm oils. Other useful anionic surfactants include sodium salts of phosphated mono- and diglycerides. Exemplary sodium salts of phosphated mono- and diglycerides include food grade phosphate esters derived from vegetable oils.

The surfactant can be, for example, an ethoxylated linear alcohol, e.g., an alcohol ranging from C9 to C15 and average moles of ethoxylation of 6 to 8 (R(OC₂H₄)ₙOH, wherein R can vary and the number n can vary, an ethoxylated castor oil, an ethoxylated fatty acid, an alkoxylated alcohol sulfonate, a linear alkyl sulfate. Exemplary surfactants include alcohol ethoxylate (AE), alkoxylated linear alcohol, (ALA); phosphated mono- and diglycerides; ethoxylated alcohol (EA); disodium lauryl sulfosuccinate (DLS); sodium dodecyl sulfate, (SDS); diphenyl oxide disulfonate (DOD); and dodecyl diphenyl oxide disulfonate, (DDOD).

The surfactant can be a single surfactant or can be a mixture of two, three, four, five, six or more different surfactants. For example a surfactant can be a mixture of alcohol ethoxylate (AE) and alkoxylated linear alcohol (ALA).

The concentration of the surfactant can vary. The concentration of the surfactant can range from about 0.5% by weight to about 20% by weight. Thus, the surfactant concentration can be about 0.5% by weight, 1% by weight, 1.5% by weight, 2% by weight, 2.5% by weight, 3% by weight, 3.5% by weight, 4% by weight, 4.5% by weight, 5% by weight, 5.5% by weight, 6% by weight, 6.5% by weight, 7% by weight, 7.5% by weight, 8% by weight, 8.5% by weight, 9% by weight, 9.5% by weight, 10% by weight, 10.5% by weight, 11% by weight, 11.5% by weight, 12% by weight, 12.5% by weight, 13% by weight, 13.5% by weight, 14% by weight, 14.5% by weight, 15% by weight, 15.5% by weight, 16% by weight, 16.5% by weight, 17% by weight, 17.5% by weight, 18.5% by weight, 19% by weight, 19.5% by weight, or 20% by weight. Regardless of the concentration, the amount of surfactant should be sufficient to promote the formation of micelles, that is, it should be above the critical micelle concentration, and sufficient to stabilize the percarboxylic acid.

In some embodiments, the compositions can include or exclude a stabilizer, for example, for stabilizing the surfactant emulsion, for further stabilizing the peroxyacid, for chelation of metal ions, and for inhibition of precipitation. A stabilizer can be a hydroxyacid. Exemplary hydroxyacid include, without limitation, citric acid, isocitric acid, lactic acid, gluconic acid, and malic acid. A stabilizer can be a metal chelator such as ethylenediaminetetraacetic acid (EDTA). Metal chelators are useful in water produced in oilfields in order to keep metal ions in solution or otherwise interfering with the function of the surfactant.

The concentration of the stabilizer can vary. The concentration of the stabilizer can range from about 0.1% by weight to about 5% by weight. Thus, the stabilizer concentration can be about 0.1% by weight, 0.2% by weight, 0.5% by weight, 0.7% by weight, 0.8% by weight, 1.0% by weight, 1.2% by weight, 0.3% by weight, 1.4% by weight, 1.5% by weight, 1.7% by weight, 2.0% by weight, 2.5% by weight, 3.0% by weight, 3.5% by weight, 4.0% by weight, 4.5% by weight, or 5.0% by weight.

Provided herein are methods of making the micellar delivery system. The source of active oxygen, the organic acid, and the surfactant can be prepared as aqueous stock solutions and diluted for use. The source of active oxygen, the organic acid, and the surfactant can be combined in an aqueous solution. The source of active oxygen, the organic acid, and the surfactant can be combined simultaneously, substantially concurrently or sequentially. For example, the source of active oxygen, the organic acid, and the surfactant can be combined over a period of about 15 seconds, 20 seconds, 30 seconds, 40 seconds, 50 seconds, 60 seconds, 90 seconds, 120 seconds, 150 seconds, 3 minutes, 3.5 minutes, 4 minutes, 4.5 minutes, 5.0 minutes, 5.5 minutes, 6.0 minutes, 6.5 minutes, 7.0 minutes, 7.5 minutes, 8.0 minutes, 8.5 minutes, 9.0 minutes, 9.5 minutes, 10 minutes, 12 minutes, 15 minutes, 18 minutes, 20 minutes, 25 minutes, or 30 minutes. In some embodiments, the organic acid can be diluted into water, followed by addition of the surfactant. The source of active oxygen can subsequently be added to the mixture of organic acid and surfactant. In some embodiments the source of active oxygen can be added to the mixture of organic acid and surfactant once the organic acid and surfactant have been combined, for example, within a few minutes. In some embodiments, the mixture of organic acid and surfactant can be stored in the source of active oxygen can be added at a later time. In some embodiments, components can be mixed, for example, by stirring or mild agitation.

The source of active oxygen, the organic acid, and the surfactant can be combined in any order. In some embodiments, the source of active oxygen can be added subsequent to the combination of the organic acid and the surfactant. The aqueous solution can be incubated to generate an equilibrium percarboxylic acid solution in a micellar system. The formation of percarboxylic acid can be monitored by autotitration or other methods, for example, spectrophotometric methods, wet titration test kits, or HPLC, over a period of hours, days, or weeks to determine if equilibrium has been reached. The time to reach equilibrium can vary based on a number of factors, including, for example, the organic acid concentration, the source of active oxygen concentration, the specific surfactant, the temperature, in the presence of additives, for example, sulfuric acid catalysts. The time to reach equilibrium can be, for example, from about 8 days to about 50 days, for example from about 8 days, 10 days, 12 days, 14 days, 18 days, 20 days, 21 days, 24 days, 28 days, 30 days, 35 days, 40 days, 45 days, or 50 days. In general, an equilibrium solution is one in which the measured concentration of the percarboxylic acid does not change by more than about 1% over a period of about seven days.

Depending upon the structure of the organic acid, a variety of different percarboxylic acids can be generated in the micellar system. The generated percarboxylic acids can have, for example, 2-12 carbon atoms. The percarboxylic acids can include organic aliphatic peracids having 2 or 3 carbon atoms, e.g., peracetic acid and peroxypropanoic acid. Additional peracids can be formed from organic aliphatic monocarboxylic acids having 4 or more carbon atoms, such as acetic acid (ethanoic acid), propionic acid (propanoic acid), butyric acid (butanoic acid), iso-butyric acid (2-methyl-propanoic acid), valeric acid (pentanoic acid), 2-methyl-butanoic acid, iso-valeric acid (3-methyl-butanoic), 2,2-dimethyl-propanoic acid, hexanoic acid, heptanoic acid, and octanoic acid. Other percarboxylic acids can be formed from dicarboxylic and tricarboxylic organic acids, for example, citric, oxalic, malonic, and glutaric, succinic, malic, glycolic, and adipic acids.

In general, equilibrated percarboxylic acid solutions are solutions in which the concentration of the percarboxylic acid, for example peracetic acid, remains stable over time. Typical equilibrated percarboxylic acid solutions vary by about 1% or less than the targeted concentration.

The equilibrium concentration of percarboxylic acid can vary depending upon the specific source of active oxygen, the organic acid, and the surfactant. In general, useful equilibrium concentrations will be about 8-20% weight of the total composition. Thus the equilibrium concentration of the generated percarboxylic acid, for example, peracetic acid, can be from about 8% by weight, 8.5% by weight, 9% by weight, 9.5% by weight, 10% by weight, 10.5% by weight, 11% by weight, 11.5% by weight, 12% by weight, 12.5% by weight, 13% by weight, 13.5% by weight, 14% by weight, 14.5% by weight, 15% by weight, 15.5% by weight, 16% by weight, 16.5% by weight, 17% by weight, 17.5% by weight, 18% by weight, 18.5% by weight, 19% by weight, 19.5% by weight, or 20% by weight.

The equilibrium percarboxylic acid solution in the micellar system disclosed herein will generally retain about 80% of the original percarboxylic acid activity determined at the time equilibrium is reached (also referred to as active oxygen) after storage at room temperature (about 22° C.) for a period of at least about 150 days. In some embodiments, the equilibrium percarboxylic acid solution in the micellar system disclosed herein will generally retain about 75%, about 70%, about 65%, about 60%, about 55%, or about 50% of the original percarboxylic acid activity determined at the time equilibrium is reached, following storage for a period of at least about hundred and 50 days.

The pH of the equilibrium percarboxylic acid solution in the micellar systems will generally be in the acid range. The pH can range from about less than 1 to less than 4. The pH can be about pH 0.5, about pH 0.8, about pH 1.0, about pH 1.1, about pH 1.2, about pH 1.5, about pH 1.7, about pH 2.0, about pH 2.2, about pH 2.5, about pH 2.7, about pH 3.0, about pH 3.2, about pH 3.5, about pH 3.7, or about pH 4.0.

The compositions disclosed herein are generally useful for treatment of water that is microbially contaminated or that is at risk for or suspected of being microbially contaminated. The compositions are also useful for the treatment of equipment, for example, pipes, drilling equipment, tanks, or other industrial equipment that has been in contact with water that is microbially contaminated with or that is at risk for or suspected of being microbially contaminated. The compositions are also useful for the treatment of equipment that is contaminated with a biofilm. In some embodiments, the compositions are useful for the treatment of medical equipment. In some embodiments, the compositions are useful for the treatment of equipment and surfaces used in food preparation.

The water can be produced water from oil and gasfield operations, industrial wastewater, municipal wastewater, process water, combined sewer overflow, rain water, flood water, storm runoff water or drinking water. The water can be fresh water, pond water, brackish water, sea water, or a brine.

The methods disclosed herein are particularly useful for treatment of produced water resulting from oil and gas production. Such produced water, which may not be suitable for treatment at municipal wastewater treatment facilities, is often pumped into previously produced underground injection wells. Microbial contamination of such water can result in biofilm formation on well drilling and pumping equipment. Typical well-pumping formulations can include a biocide, friction reducer, surfactant, clay stabilizer, and corrosion inhibitor that are mixed together on-site and pumped down into the well. Such components may be incompatible especially when contacted with the high salinity brines found in oilfields. Approaches to overcome this incompatibility can include diluting the components and extending the amount and time of treatment. But, these approaches can result in higher cost and are not always effective at removing microbial contamination and biofilms. The compositions disclosed herein can be used for treatment of process water to treat existing biofilms, reduce the likelihood of formation of new biofilms and to solubilize sludge or tar that builds up on the pipes and drilling equipment. Such compositions can also be incorporated into fracturing fluids to reduce microbial contamination.

The compositions are compatible with high salinity conditions, for example water that contains 0.5%, 1.0%, 2.0%, 3.0%, 4.0% 5%, 6%, 7%, 8%, 9% 10%, 15%, 20%, 30%, 35% or more of dissolved salts. The compositions are also useful and remain stable under relatively high temperature conditions, for example, at above 30° C., 35° C., 40° C., 50° C., 55° C., 60° C., or more.

The compositions can be added to the water to be treated in an amount sufficient to provide about 1 ppm to about 1000 ppm of active percarboxylic acid in the water to be treated. Thus, for example, the equilibrium percarboxylic acid solution in the micellar system can be added to water to be treated or water to be used in treatment of equipment at concentrations of active percarboxylic acid of about 1 ppm, about 2 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 120 ppm, about 150 ppm, about 180 ppm, about 200 ppm, about 300 ppm, about 400 ppm, about 500 ppm, about 600 ppm, about 700 ppm, about 800 ppm, about 900 ppm, or about 1000 ppm. In some embodiments the concentration of equilibrium percarboxylic acid solution in water to be treated can be from about 50 to about 100 ppm. In some embodiments the concentration of equilibrium percarboxylic acid solution in the micellar system can be about 58 ppm, about 59 ppm, about 63 ppm, about 66 ppm, about 67 ppm, or about 68 ppm.

In some embodiments, the compositions can be added to the water to be treated based on the weight of the micellar composition, for example, about 50 ppm to about 8000 ppm.

The duration of treatment can vary. In general, useful treatments will result in a reduction of viable microbes in the treated water. With respect to biofilms, efficacy of treatment can be determined by a reduction in the extent of the biofilm on the contaminated surface. The duration of treatment can vary from about 30 minutes to 24 hours or more. Exemplary treatment times can be about 30 minutes, about one hour, about two hours, about four hours, about six hours, about eight hours, about 10 hours, about 12 hours, about 15 hours, about 18 hours, about 20 hours, or about 24 hours.

In general, a reduction of microbial contamination can be assayed by determining the level of viable microbes in the water. In some embodiments, a reduction of microbial contamination can be a reduction of about 50%, about 80% about 90%, about 95%, about 99% or about 99.9% of the contamination of the treated water compared to the level in the water prior to treatment or compared to a reference level. Alternatively, or in addition, the reduction can be specified as a Log₁₀ reduction. Thus in some embodiments a reduction of microbial contamination can be a 1, 2, 3, 4, 5, 6, or 7 Log reduction relative to an untreated control sample. Levels of microbial contamination can be determined, for example, by standard cultural methods involving microbial outgrowth, nucleic acid amplification techniques such as polymerase chain reaction, and immunoassays.

The compositions disclosed herein are also generally useful for cleaning and sanitizing surfaces or equipment, particularly equipment used in oil and gasfield operations. Such surfaces are often covered with deposits of sludge, tar, inorganic scale, gelled friction reducer, polymers and partially hydrolyzed polyacrylamide or other byproducts of well drilling that can be difficult to remove in a subterranean environment.

The compositions and methods disclosed herein can be used to treat water and equipment exposed to a variety of microbial contaminants including, for example, bacteria, viruses, fungi, protozoa, and algae. The compositions can be applied to both planktonic and sessile forms of bacteria, viruses, fungi, protozoa, and algae. The compositions can be applied to both aerobic microorganisms and anaerobic microorganisms, for example, gram positive bacteria such as Staphylococcus aureus, Bacillus species (sp.) such as Bacillus subtilis, Clostridia sp.; gram negative bacteria, e.g., Escherichia coli, Pseudomonas sp., such as Pseudomonas aeruginosa and Pseudomonas fluorescens, Klebsiella pneumoniae, Legionella pneumophila, Enterobacter sp. such as Enterobacter aerogenes, Serratia sp. such as Serratia marcesens, Desulfovibrio sp. such as Desulfovibrio desulfuricans and Desulfovibrio salexigens, Desulfotomaculum sp. such as Desulfotomaculum nigrificans; yeasts, e.g., Saccharomyces cerevisiae, Candida albicans; molds, e.g., Cephalosporium acremonium, Penicillium notatum, Aureobasidium pullulans; filamentous fungi, e.g., Aspergillus niger, Cladosporium resinae; algae, e.g., Chlorella vulgaris, Euglena gracilis, Selenastrum capricornutum; and other analogous microorganisms, e.g., phytoplankton and protozoa; viruses e.g., hepatitis virus, and enteroviruses such poliovirus, echo virus, coxsackie virus, norovirus, SARS, and JC virus. The compositions are also useful in treatment of water and surfaces exposed to bacterial spores, for example, spores produced by Clostridium sp.

The sulfur- or sulfate-reducing bacteria, e.g., Desulfovibrio and Desulfotomaculum species, which convert sulfur or sulfates present in such environments into sulfides, particularly hydrogen sulfide, are a concern in subterranean wells. These species can cause souring in gas and oil products that are recovered from an underground formation. Such gas or oil souring reduces the quality of the recovered product. The sulfides typically need to be removed by chemical treatment of the petroleum product in downstream surface treatment processing. Sulfur- or sulfate-reducing bacteria, e.g., Desulfovibrio and Desulfotomaculum species, are not easily treated with biocides. Sulfate-reducing bacteria are normally sessile bacteria, i.e., they attach themselves to solid surfaces, as opposed to being free-floating in the aqueous fluid. In addition, sulfate-reducing bacteria are generally found in combination with slime-forming bacteria, in films consisting of a biopolymer matrix embedded with bacteria. The interior of these biofilms is anaerobic, which is highly conducive to the growth of sulfate-reducing bacteria even if the surrounding environment is aerobic.

### EXAMPLES

### Example 1: Materials and Methods

Surfactant-peroxyacid solutions were prepared by combining an organic acid, hydrogen peroxide (50% solution from PeroxyChem LLC), a surfactant, and optionally, a stabilizer by dissolving the appropriate weight of the components in deionized (DI) water to the desired concentration. The solutions were kept at room temperature and periodically tested for the concentration of the components using an auto-titrator and standard titration methods. Typical concentrations of the components are shown in the Table 1.

TABLE 1
Components used for surfactant-peroxyacid solutions

Concentration, %

| Component | Initial | Final |
|---|---|---|
| Hydrogen | 11-18 | 8-10 |
| peroxide | | |
| Organic Acid | 35-47 | 26-34 |
| Percarboxylic | 0 | 11-15 |
| Acid | | |
| Surfactant | 1-15 | 1-15 |
| Stabilizer | 0-1.5 | 0-1.5 |

The following surfactants were analyzed: alcohol ethoxylate (AE) (Lumulse™ EST-916 obtained from Vantage Specialties 100% active); alkoxylated linear alcohol, (ALA) (Lumulse™ EST-500 obtained from Vantage Specialties (100% active); phosphated mono- and diglycerides (PMDG) (Lamchem™ PE 130K obtained from Vantage Specialties (100% active); sodium lauroyl glutamate (SLG) (Amisoft® LS-11) obtained from Ajinomoto Co, 100% active); ethoxylated alcohol (EA) (Biosoft® N91-8 obtained from Stepan Co, 99% active); disodium lauryl sulfosuccinate (DLS) (Cola®Mate LA-40 obtained from Colonial Chemical, 40% active); sodium dodecyl sulfate, (SDS) obtained from Sigma-Aldrich, 98% active; diphenyl oxide disulfonate (DOD) (Dowfax® 3B2 obtained from Dow Chemical Co., 45% active); dodecyl diphenyl oxide disulfonate, (DDOD) (Calfax® DB-45 obtained from Pilot Chemical Co., 45% active).

### Example 2

A solution containing a source of active oxygen (AO) and a surfactant was prepared by dissolving glacial acetic acid, hydrogen peroxide, and a surfactant in DI water at room temperature. The surfactant was sodium lauroyl glutamate (SLG) at a concentration of 1.0% by weight. The initial levels of peracetic acid (PAA), hydrogen peroxide and active oxygen were analyzed as described in Example 1. The solution was then stored at 22° C. At intervals, the levels of peracetic acid (PAA), hydrogen peroxide and active oxygen were analyzed. The concentrations of the components are shown in the Table 2.

TABLE 2
Peracetic Acid Formation Kinetics in the presence of Surfactant

| | Concentration, % | | | | |
|---|---|---|---|---|---|
| Component | 0 days | 4 days | 8 days | 28 days | 41 days |
| Hydrogen | 17.4 | 16.3 | 14.8 | 11.7 | 11.0 |
| Peroxide | | | | | |
| Acetic Acid | 47.7 | 41.5 | 38.1 | 32.9 | 32.1 |
| Peracetic Acid | 0 | 4.2 | 7.1 | 13.8 | 15.0 |
| Total Available | 8.56 | 8.56 | 8.46 | 8.43 | 8.35 |
| Active Oxygen | | | | | |

As shown in Table 2, peracetic acid formed by a reaction of acetic acid with hydrogen peroxide in the presence of surfactant. Equilibrium concentration levels of peracetic acid were reached after several weeks of incubation. The concentration of total available active oxygen in the system was relatively stable for the duration of the experiment. Total available active oxygen (“AO”), that is, the summation of active oxygen across the total number of peroxygen containing moieties, was calculated according to the formula: AO=Σⁿ, wherein n=the amount active oxygen for each compound in the solution. The percent of active oxygen for a given compound can be determined by MW O₂/MW compound×100%. Peracetic acid contains 16/76×100%, which is 21% of active oxygen. Hydrogen peroxide contains 16/34×100%, which is 47% of active oxygen. Thus, the total amount AO can be calculated as: [peracetic acid wt %]×0.21+[hydrogen peroxide wt %]×0.47. As shown in Table 2, the peracetic acid equilibrium concentration of 15% was reached at 41 days.

The solution was clear and homogeneous when initially prepared and remained so for the duration of the experiment.

### Example 3

Solutions containing a source of active oxygen (AO) and various surfactants were prepared as described in Example 1. The initial levels of peracetic acid (PAA) and hydrogen peroxide were analyzed as described in Example 1. The initial measurements of both peracetic acid and hydrogen peroxide (see the columns in Table 3 headed as “initial.”) were taken after about 15 days when equilibrium was generally reached. The solutions were then stored at 22° C. The levels of peracetic acid and hydrogen peroxide were determined at the time points shown Table 3 below.

As shown in Table 3, the ability of the different surfactants to sustain peracetic acid stability varied. The effect of various surfactants was also evaluated by visual inspection. Solutions were considered stable when no phase separation, solidification, or gas evolution was noted. As shown in Table 3, certain surfactants were physically incompatible with the starting materials and resulted in phase separation or solidification of the solutions. Those combinations that demonstrated stability and compatibility were selected for further analysis.

TABLE 3
Stability of Percarboxylic Acid -Surfactant Compositions

| | Surfactant | Days | Peracetic | | Hydrogen | |
|---|---|---|---|---|---|---|
| | Concentration, | at | Acid, % | | Peroxide, % | |
| Surfactant | % wt | 20° C. | Initial | Final | Initial | Final |
| SDS | 5.0 | 43 | 13.9 | 13.6 | 8.5 | 8.3 |
| SDS | 10.0 | 43 | 13.0 | 11.8 | 8.1 | 7.4 |
| DLS | 2.0 | 43 | 12.6 | 11.8 | 8.4 | 8.2 |
| DLS | 4.0 | 25 | Sample solidified | | | |
| ALA | 5.0 | 43 | 13.7 | 13.4 | 8.6 | 8.5 |
| ALA | 10.0 | 43 | 12.9 | 12.2 | 8.1 | 8.1 |
| DDOD | 2.2 | 38 | 13.6 | 9.9 | 8.8 | 6.7 |
| DDOD | 4.5 | 38 | 12.4 | 6.5 | 8.3 | 4.9 |
| DOD | 2.2 | 38 | 13.6 | 10.0 | 8.8 | 6.7 |
| DOD | 4.5 | 38 | 12.4 | 6.6 | 8.4 | 5.0 |

| | | | |
|---|---|---|---|
| SLG | 2.0 | 49 | Phase separation |
| SLG | 10.0 | n/a | Did not dissolve |

### Example 4

Solutions containing a source of active oxygen (AO) and various additional surfactants were prepared as described in Example 3. The initial concentration of active oxygen (AO⁰) was determined in the solutions, which were then were stored at 22° C. Periodically, compositions were titrated and the concentration of active oxygen (AO) was determined. The comparative stability of solutions was evaluated by the ratio of AO/AO⁰, where AO⁰ is the initial active oxygen content.

As shown in Table 4, the selected surfactants resulted in sustained peracetic acid stability.

TABLE 4
Stability of PAA-Surfactant Compositions at 22° C.

| | | Days at | | |
|---|---|---|---|---|
| Surfactant | Concentration, % | 22° C. | AO/AO⁰ | Appearance |
| AE | 5 | 122 | 0.95 | Homogeneous |
| AE | 10 | 122 | 0.89 | Homogeneous |
| PMDG | 5 | 122 | 0.90 | Homogeneous |
| PMDG | 10 | 122 | 0.81 | Homogeneous |
| EA | 5 | 163 | 0.88 | Homogeneous |
| EA | 10 | 163 | 0.81 | Homogeneous |

### Example 5

The dispersion state of the PAA-surfactant solutions was analyzed. Typically, the individual suspension particles in a colloidal solution scatter and reflect light (also referred to as the “Tyndall Effect”), whereas true solutions, which do not contain suspended particles, do not produce light scattering. Flasks containing the aqueous solutions from Example 3 were irradiated by laser emitted from a laser pointer. The laser passed through the aqueous solutions, and essentially no “light path” appeared, suggesting that the “Tyndall effect” in the solutions was very weak. As a control, a commercially available micro-emulsion was also irradiated by the laser, and a “light path” appeared, consistent with the “Tyndall effect” expected from a micro-emulsion. These results suggested that dispersion state in the aqueous solutions of the PAA-surfactant systems prepared in Example 3 were relatively uniform. These results also suggested that the surfactant micelles were smaller than the 40 to 900 nanometer micelles in the commercially available micro-emulsion control that produced the Tyndall effect. These results further suggested that the PAA-surfactant system resulted in ultrafine or nanoscale micelles.

### Example 6

We evaluated the effect of temperature on the stability of PAA-surfactant solutions. An equilibrium PAA solution in a micellar system was prepared containing 12.5% by weight of peracetic acid, 9.4% of hydrogen peroxide, and 4.5% of the surfactant alcohol ethoxylate (AE) as described in Example 3. The solution was also stabilized by addition of sulfuric acid (0.33%), citric acid (0.50%) and methylene phosphonic acid (Dequest, 0.83%). Aliquots of the equilibrium peracetic acid-surfactant composition were incubated at 35° C., 45° C., or 55° C.

At intervals, the solutions were titrated and the concentration of active oxygen (AO) was determined. The comparative stability of solutions was evaluated by the ratio of AO/AO⁰, where AO⁰ is the initial active oxygen content.

The results are shown in the Table 5. These results indicate that the PAA-AE solution was relatively stable. In addition, no phase separation or precipitation observed in any of the solutions.

TABLE 5
Stability of PAA-Surfactant Composition at 35-55° C.

| Temperature, | | |
|---|---|---|
| ° C. | Days | AO/AO⁰ |
| 35 | 8 | 1.00 |
| 35 | 21 | 0.97 |
| 35 | 35 | 0.95 |
| 45 | 8 | 0.93 |
| 45 | 21 | 0.84 |
| 45 | 35 | 0.76 |
| 55 | 8 | 0.86 |
| 55 | 21 | 0.70 |
| 55 | 35 | 0.58 |

### Example 7

We evaluated the effect of equilibrium PAA-solutions in a micellar system under simulated oilfield conditions. A solution containing 9.5% PAA and 4.5% of the surfactant alkoxylated linear alcohol, ALA, was prepared as described in Example 3. The test liquid was EZ-MUD® Plus from Halliburton, which is an aqueous solution of high molecular weight partially hydrolyzed polyacrylamide (HPAM). That liquid was added to tap water to a final concentration of 1.25%. In addition, KCl was added to the solution in amount of 1% by weight to mimic typical slickwater used in oilfield. The simulated oilfield composition was then treated with treated by 1,000 ppm of the PAA-ALA solution.

Viscosity of the gel was measured using Viscometer Grace M3500 at 60-300 rpm using standard bob R1. Measurements were done at 22° C. and 45° C.

The results of this analysis are shown in Table 6. Each data point is an average of three experimental results.

TABLE 6
Viscosity of 1.25% HPAM at 22° C., cps

| | | |
|---|---|---|
| Speed, | 22° C. | 45° C. |

| rpm | Control | Treated | Control | Treated |
|---|---|---|---|---|
| 60 | 53 | 39 | 50 | 27 |
| 100 | 42 | 31 | 40 | 24 |
| 200 | 31 | 24 | 29 | 18 |
| 300 | 28 | 22 | 26 | 15 |

As shown in Table 6, the viscosity of the HPAM solution at 22° C. decreased by about 22-26% after treatment with the PAA-ALA composition depending on the rotation speed. The viscosity of the HPAM solution at 45° C. decreased by about about 42-46% after treatment. The viscosity of the treated and control test liquids was re-measured after 72 hours. There was virtually no further change in the viscosity.

### Example 8

We evaluated the effect of equilibrium PAA solutions in a micellar system on the surface tension in a brine solution. High salinity brine typical of oilfield conditions was prepared by dissolving inorganic chlorides in deionized water to final concentrations of 8% NaCl, 1% KCl, and 1% CaCl₂). A solution containing 12.5% by weight of peracetic acid and 4.5% of the surfactant alcohol ethoxylate (AE) was prepared as described in Example 3. The PAA-AE solution was added to the brine solution at different concentrations (300 ppm, 600 ppm, and 1200 ppm.)

The surface tension was determined using a Traube Stalagmometer at 22° C. The results are shown in Table 7. Each data point is an average of 12 measurements.

TABLE 7
Surface Tension of High Salinity Brine at 22° C.

| | Surface |
|---|---|
| Composition, | Tension, |
| ppm | mN/m |
| 0 | 80.7 |
| 300 | 47.9 |
| 600 | 42.2 |
| 1200 | 38.6 |

As shown in Table 7, treatment of the brine with the equilibrium PAA solution in a micellar system resulted in a dose-dependent decrease in surface tension. These data suggested that the compositions can effectively deliver equilibrium PAA to hydrophobic surfaces, such as those found in the walls of oil and gas wells.

### Example 9

We evaluated the biocidal activity of PAA-surfactant solutions on microbial biofilms using a CDC Biofilm reactor from BioSurface Technologies. This reactor supplies a continuous flow of nutrient broth through a container that exposes bacteria growing on glass coupons to shear forces. The setup mimics at least two features typical for oilfield operations: a renewable nutrient source and shear forces applied to the biofilms. All reactor parts were cleaned with a solution of 1% Neutrad lab soap and rinsed well with deionized water, and allowed to dry prior to autoclaving on a 20 minutes gravity cycle to sterilize.

Pseudomonas aeruginosa (ATCC 15442) biofilm was grown for 48 hours in the biofilm reactor on glass coupons at 25° C. A solution containing 300 mg/L of sterile trypticase soy broth (TSB) was used as nutrient feed. 1 mL of the working inoculum of P. aeruginosa was added through the inoculation port. The first step was a 24 hours batch phase followed by 24 hours in continuous flow mode, when 100 mg/L TSB solution was pumped into the stirring reactor for about 24 hours at room temperature to create a matured biofilm on the coupon surfaces.

Upon completion of the biofilm growth phase, the coupons were removed and rinsed by immersion into 30 mL dilution buffer. Coupons were placed into sterile centrifuge test tubes and 4 mL biocide or buffer were added. Then the tubes were vortexed on low speed to ensure complete coverage of the coupon. At the appropriate time, the biocide was poured off, and reserved for chemical analysis of PAA and hydrogen peroxide. Then, a 10 mL aliquot of chemical neutralizing Letheen broth with 0.5% sodium thiosulfate was added to each tube. One treated coupon from each treatment group was removed at final time point for visual analysis.

Three solutions were used as biocides: PAA without surfactant; and PAA/hydrogen peroxide at 11.1%/4.2% and the surfactants alcohol ethoxylate (AE) and alkoxylated linear alcohol, ALA (“Composition 1”); and PAA/hydrogen peroxide at 12.6%/9.1% and the surfactants alcohol ethoxylate (AE) and alkoxylated linear alcohol, ALA (“Composition 2”). The compositions of the biocides are shown in the Table 8.

TABLE 8
Biocide Composition

| Biocide | PAA | Composition 1 | Composition 2 |
|---|---|---|---|
| PAA, % | 15.7 | 11.1 | 12.6 |
| H2O2, % | 10.4 | 4.2 | 9.1 |
| Surfactant 1, | NA | AE | AE |
| type | | | |
| Surfactant 1, % | | 2.5 | 3.0 |
| Surfactant 2, | | ALA | ALA |
| type | | | |
| Surfactant 2, % | | 1.0 | 1.5 |
| Stabilizer 1, | Dequest | Citric Acid | Citric Acid |
| type | | | |
| Stabilizer 1, % | 0.6 | 0.3 | 0.5 |
| Stabilizer 2, | NA | Dequest | Dequest |
| Type | | | |
| Stabilizer 2, % | | 0.5 | 0.5 |

The compositions were diluted with deionized water before use, such that the initial concentration of PAA-surfactant active ingredient was 100 ppm.

In order to recover remaining viable bacteria from the coupons, the test tubes with coupons were vortexed for 30 s on highest setting, and then sonicated for 30 s at 45 kHz. This treatment was then repeated twice. After that, the broth was diluted serially into Butterfield's buffer, and the dilutions plated on 3M™ Petrifilm™ Aerobic Count Plates. The plates were incubated for 48 hours at 35° C., and then counted. Calculations were performed to obtain the Log₁₀ CFU/mL of the solutions at each time point.

PAA and Hydrogen peroxide concentrations were monitored during the test by using Chemetrics test kits K-7913F and K-5543. The results of this experiment are shown in Table 9.

TABLE 9
Average Log₁₀ Reduction and Oxidizer Concentration

| | | PAA, | H₂O₂, | Log₁₀ | Log₁₀ |
|---|---|---|---|---|---|
| Composition | Time, hrs | ppm | ppm | remaining | reduction |
| Control | 4 | n/a | n/a | 9.2 | N/A |
| PAA | 1 | 63 | 35 | 7.8 | 1.4 |
| PAA | 2 | 54 | 27 | 7.0 | 2.2 |
| PAA | 4 | 30 | 10 | 6.1 | 3.1 |
| Composition 1 | 1 | 68 | 29 | 7.7 | 1.5 |
| Composition 1 | 2 | 66 | 28 | 5.7 | 3.5 |
| Composition 1 | 4 | 58 | 18 | 0.0 | Total kill |
| Composition 2 | 1 | 67 | 45 | 7.4 | 1.8 |
| Composition 2 | 2 | 63 | 35 | 5.2 | 4.0 |
| Composition 2 | 4 | 59 | 28 | 0.0 | Total kill |

As shown in Table 9, both equilibrium PAA solutions in a micellar system-were more active biocides than was peracetic acid alone at the same concentration. Compositions 1 and 2 also provided enhanced stability of the oxidizers (PAA and H₂O₂) in the treatment solution after four hours compared to peracetic acid alone.

### Example 10

We further evaluated the biocidal activity of PAA-surfactant solutions on microbial biofilms using a CDC Biofilm reactor from BioSurface Technologies as described in Example 9. The three biocide solutions were also as described in Example 9, but the contact time was increased to about 72 hours under agitation. Additionally, for this test, the biocide aliquot was increased from the standard method amount of 4 mL up to 30 mL. These adjustments were made to more accurately simulate expected field conditions. The recovery was performed as described in the Example 8. The testing showed complete kill for all three biocides. Chemical analysis indicated only a slight reduction in concentrations of both PAA and hydrogen peroxide over the 72-hour time period.

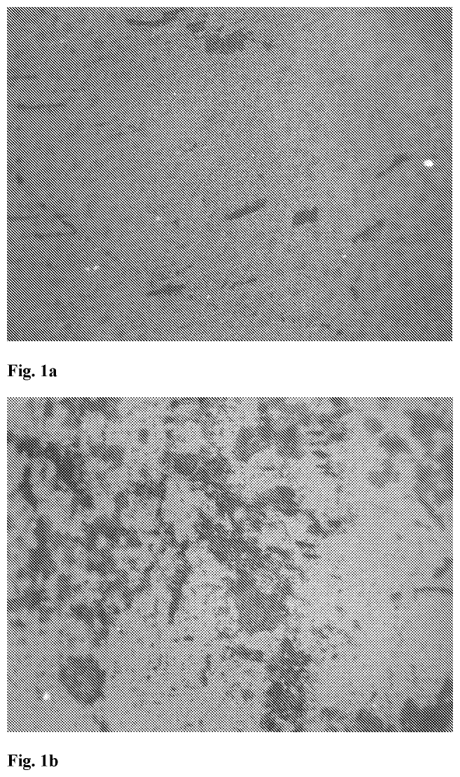

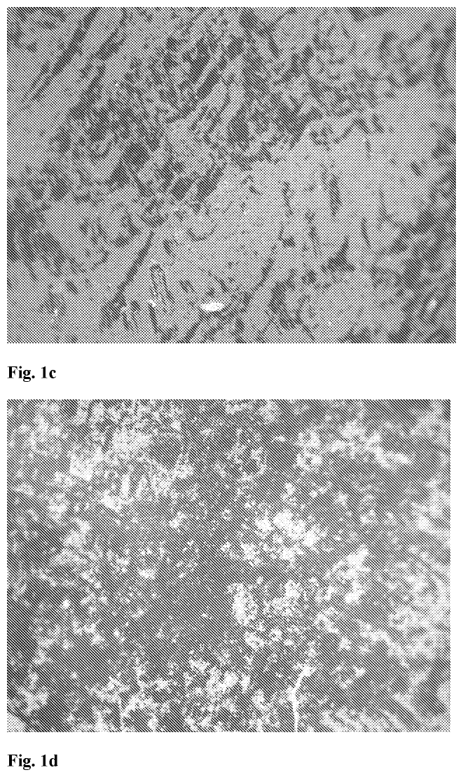

In addition to microbial recovery, visual examination of the biofilms remaining on the glass coupons after the treatment with biocides was made. Coupons were observed visually, and with the aid of the Leica optical microscope. Images were captured with the Leica equipment, and shown in FIG. 1a-1d.

Visual examination showed that more biofilm was removed from the coupons treated with the Compositions 1 and 2, then those treated with PAA alone. The untreated control coupons were completely coated with the biofilm.

1-24. (canceled)

25. A micellar system comprising an equilibrium peroxycarboxylic acid solution and a surfactant.

26. The micellar system of claim 25, wherein the equilibrium peroxycarboxylic acid solution comprises a percarboxylic acid, an organic acid, and hydrogen peroxide.

27. The micellar system of claim 26, wherein the percarboxylic acid is peracetic acid.

28. The composition of claim 26, wherein the organic acid is acetic acid.

29. The micellar system of claim 25, wherein the micelles comprise a non-ionic surfactant.

30. The micellar system of claim 25, wherein the micelles comprise an anionic surfactant.

31. The micellar system of claim 25, wherein the micelles comprise a surfactant wherein the surfactant is an alcohol ethoxylate, an alkoxylated linear alcohol, ethoxylated castor oil, an alkoxylated fatty acid, an alkoxylated coconut oil, an alcohol sulfate, a phosphated mono glyceride, a phosphated diglyceride, or a combination thereof.

32. The micellar system of claim 25, further comprising a stabilizing agent.

33. The micellar system of claim 32, wherein the stabilizing agent is a hydroxy acid.

34. The micellar system of claim 33, wherein the hydroxy acid is citric acid, malic acid, lactic acid, salicylic acid, or glycolic acid, or a combination thereof.

35. A method of preparing a micellar system comprising an equilibrium peroxycarboxylic acid solution, the method comprising:
a) combining about 30-50 weight % of organic acid, about 10-20 weight % of a source of active oxygen, and about 1-15 weight % of a surfactant in an aqueous solution;
b) incubating the aqueous solution for a time sufficient to generate the equilibrium peroxycarboxylic acid solution.

36. The method of claim 35, wherein the organic acid, the source of active oxygen, and the surfactant are combined simultaneously.

37. The method of claim 35, wherein the organic acid, the source of active oxygen, and the surfactant are combined sequentially.

38. The method of claim 35, where in the incubation step is from about 8 days to about 50 days.

39. A method of reducing microbial contamination in an aqueous fluid, the method comprising contacting the aqueous fluid with a composition comprising a micellar system, wherein the micellar system comprises an equilibrium peroxycarboxylic acid solution and a surfactant, wherein said contacting is maintained for a time sufficient to reduce microbial levels in the aqueous fluid.

40. The method of claim 39, wherein the aqueous fluid is fresh water, pond water, sea water, brackish water or a brine.

41. The method of claim 39, wherein the aqueous fluid is an oilfield fluid, produced water, tower water or a combination thereof.

42. The method of claim 39, wherein the composition is added to the aqueous fluid in an amount sufficient to provide about 10 ppm to about 1000 ppm of active percarboxylic acid in the aqueous fluid to be treated.

43. The method of claim 39, wherein the composition comprising a micellar system is added to the aqueous fluid in an amount sufficient to provide about 50 ppm to about 8000 ppm of the composition.

44. The method of claim 39, wherein the percarboxylic acid is peracetic acid.

45-53. (canceled)
